(19) United States
(12) Patent Application Publication
(10) Pub. No.: US 2019/0217534 A1
(43) Pub. Date: Jul. 18, 2019

(54) Method and apparatus for generating three-dimensional objects

(71) Applicant: Boomer Advanced Manufacturing Solutions Pty Ltd, Red Hill (AU)

(72) Inventors: Jan Verboomen, Brisbane (AU); Steven Verboomen, Brisbane (AU)

(21) Appl. No.: 16/311,452

(22) PCT Filed: Jun. 22, 2017
(86) PCT No.: PCT/AU2017/050633

§ 371 Date: Dec. 19, 2018

(30) Foreign Application Priority Data
Jun. 22, 2016 (AU) 2016902449

(51) Int. Cl. B29C 64/135; B29C 64/245; B29C 64/264; B33Y 10/00; B33Y 30/00

(52) U.S. Cl. CPC B29C 64/135; B29C 64/245; B33Y 30/00; B33Y 10/00; B29C 64/264

(57) ABSTRACT

An additive manufacturing apparatus for generating a three-dimensional object, the apparatus comprising: (a) a carrier for supporting said three-dimensional objects formed thereon; (b) a transparent member to allow electromagnetic radiation to pass therethrough, the transparent member providing a build surface wherein the build surface and the carrier define a build region there-between; (c) a supply unit operatively associated with said build surface and configured to supply a material to said build surface for solidification or polymerization; (d) a first radiation source directing radiation through the transparent member to solidify the material dispensed by the supply unit on the build surface; and (e) a second radiation source positioned relative to the printed object for directing electromagnetic radiation through the build region to carry out post curing of the printed object.

### BACKGROUND

Additive manufacturing is a method of generating three dimensional objects. In such processes, a computer-generated 3D model is converted into a physical object in a layer by layer manner as opposed to a subtractive manufacturing process to build the desired object.

The additive manufacturing process involves the generation of digital cross-sectional patterns, grids or volumetric pixels, voxels, from CAD files, 3D scans or other means and solidifying a solidifiable material layer by layer or voxel by voxel or continuously to produce at least one three-dimensional object.

Additive manufacturing processes are intrinsically linked to the material chosen to achieve the best specific properties for the 3D object. The materials could be in form of liquids, pastes, powders, gels or any other aggregate state and are usually dispensed by a plurality of methods including inkjet printing, extrusion, pumping without being limited hereto. Conversion of such materials into a solid three-dimensional object is typically performed by suitable actinic radiation and/or heat.

Known methods and apparatus for additive manufacturing based on solidifying photosensitive materials are sometimes referred to as Stereolithography, Digital Light Processing, Continuous Liquid Interface Printing, Heliolithography and Inkjet 3D printing.

FIGS. 1A and 1B illustrate prior art systems for additive manufacturing or generation of 3D objects, known in the prior art. These systems operate in a top-down configuration whereby a three-dimensional object is generated in a layer by layer manner. In such prior art systems, the layer formation is performed at the top surface 1 of the growing object 2 through the solidification of the photosensitive material under activation by radiation from an electromagnetic radiation source 4. A photosensitive material is stored in a vat 3 in which the growing object, which is supported by a carrier 5, is lowered once a layer has been solidified.

FIG. 1B illustrates another apparatus known in the prior art which operates in a top-down configuration whereby the growing object is further lowered in a second medium of a different phase than the photosensitive material. The photosensitive material and the other medium cannot be mixed. The second phase provides some support to the growing objects but post-curing for large objects is limited by the second phase and how it interacts with the electromagnetic radiation. The present invention is not related to top down apparatus.

FIG. 2 illustrates another apparatus known in the prior art that is also suitable for additive manufacturing or generation of 3D objects in a bottom up configuration. Typically, in such systems a three-dimensional object is generated in a layer by layer manner whereby the layer formation is performed at the bottom surface 6 of the growing 3D object 7 through the solidification of the photosensitive material under activation by radiation from the electromagnetic radiation source 8. The photosensitive material is dispensed in a shallow vat 9 with transparent bottom through which the electromagnetic radiation selectively impinges on the photosensitive material in the build area 10. A carrier 11 is configured to receive and retain the solidified material which forms said growing object and raises said 3D object once a layer is solidified to allow a new layer of photosensitive material to be dispensed for selective curing.

FIGS. 3A and 3B also illustrate apparatus known in the art that are used for generating three dimensional (3D) objects. FIG. 3A illustrates a prior art apparatus that operates in a bottom-up configuration. FIG. 3B illustrates a prior art apparatus that operates in a top-down configuration. The hollow sections 12 and 13 generated by a bottom up apparatus (shown in FIG. 3A) do not hold any uncured photosensitive material. In contrast, the same hollow sections 12′ generated by a top down apparatus (shown in FIG. 3B) are filled with uncured photosensitive material every time the 3D object is lowered in the vat upon completion of the selective curing of the previous layer.

In the aforementioned apparatus, a thin layer of photosensitive material, often referred to as resin, is exposed to radiation typically in the ultraviolet (UV) or visible spectrum to selectively cause the resin to crosslink or ‘cure’. Two configurations are well-known: one in which new layers are formed at the bottom surface of the growing object, sometimes referred to as bottom-up (FIG. 2); the other in which new layers are formed at the top surface of growing objects, sometimes referred to as top-down (FIG. 1A).

In a top-down configuration, new layers are formed at the top surface 1 of the growing object 2, then after each irradiation step said object is lowered into the resin vat 3 until a new layer of resin of the required thickness is coated on top, and a new irradiation step takes place.

The process of submerging the growing object in a (potentially) deep pool of liquid photosensitive material limits the functional size of the object that can be created and exposes large volumes of resin to the additive manufacturing process. In a top-down configuration, hollow objects with a fully impenetrable outer wall are filled with unwanted liquid photosensitive material. Drainage of such liquid resin through purposely created drainage apertures can cause warping and wall deformation especially for large objects when lifting the object out of the vat.

In a bottom-up configuration (FIG. 2), new layers 6 are formed at the bottom surface of a growing object 7. After each irradiation step, the object is raised to allow new resin to be placed prior to the next irradiation step. Adhesion forces exist between newly solidified layers and the bottom of the shallow photosensitive material vat 9 and increase as a function of the size of the solidified layer. Removing these adhesion forces as required prior to the next photosensitive material layer being solidified, introduces mechanical stresses on the growing object and causes warping, delamination, buckling and/or misalignment. These mechanical stresses increase as a function of both the size of the solidified layer and the length of the object.

Furthermore, 3D objects generated based on solidifying photosensitive materials are only partially solidified or cured exposing large 3D objects to additional stresses through the increased weight of the growing object, causing delamination and deformation. Partially solidified or cured objects require post curing to improve their degree of cure as well as their thermal, mechanical and chemical properties.

Currently known methods for post curing include thermal heating, infrared radiation, and UV ovens. In conventional thermal heat curing, energy is transferred to the material through convection, conduction and radiation of heat resulting in long cycle times and high energy requirements. Thermal gradient during the post-curing process may result in uneven cure, residual stresses and defects in the cured polymers.

UV post curing is a continuation of the photochemical reaction which initially generates the three-dimensional object. WO 1989010249 A1 and EP 0 403 146 A2 describe a post curing method, outside of the 3D generating apparatus whereby the generated object is immersed in a liquid medium and post curing is achieved by an electromagnetic radiation source such as UV or visible light. US 20100310698 describes a post curing method as an integrated part of a top down 3D generating apparatus. In such apparatus, hollow 3D objects with a fully impenetrable outer wall are filled with unwanted liquid resin. Drainage of such liquid resin through purposely created drainage apertures can cause warping and wall deformation especially for large objects when lifting the object out of the vat.

Furthermore, post curing of internal structures of the 3D objects or solid objects is very limited if not impossible due to the interference of the holding medium with post curing radiation sources such as Infrared and microwave radiation.

Furthermore, supporting generated 3D objects in a pool of photosensitive material or partially in a separate medium adds substantial costs, dead capital or unusable material after completion of the 3D object, especially for the generation of large 3D objects.

UV post curing of multiple objects in close proximity of each other or of solid objects is difficult as UV curing only occurs in ‘line-of-sight’ meaning every point on a surface must directly exposed to the UV. Hidden areas such as inside of 3D objects with impenetrable wall or shadow areas, when post curing multiple objects simultaneously, remain uncured.

The state of the art in generation of 3D objects from photosensitive materials is such that generated objects are limited in cross-sectional size and its third dimension, and the objects' geometries are limited to thin and or open lattice wall structures. These limitations are a result of the degree of cure that can be achieved during the object generation.

The degree of cure is a function of many parameters related to the photosensitive material composition, the radiation intensity and exposure time, and layer thickness. SLA, which applies one of the highest radiation densities among photosensitive 3D object generation methods and apparatus, generated 3D objects can achieve approximately 80% degree of cure. A post-curing process using an UV chamber or thermal oven may increase curing up to 90%. It is somewhat difficult to control the post-curing times for a 3D printed object because curing times can vary with object size, material composition, temperature and UV wavelength used and ranges from minutes to hours.

### SUMMARY OF THE INVENTION

In one aspect, the invention provides an additive manufacturing apparatus for generating a three-dimensional object, the apparatus comprising:
(a) a carrier for supporting said three-dimensional object formed thereon;
(b) a transparent member to allow electromagnetic radiation to pass therethrough, the transparent member providing a build surface wherein the build surface and the carrier define a build region therebetween;
(c) a supply unit operatively associated with said build surface and configured to supply a material to said build surface for solidification or polymerization,
(d) a first radiation source directing radiation through the transparent member to solidify the material dispensed by the supply unit on the build surface; and
(e) a second radiation source positioned relative to the printed object for directing electromagnetic radiation through the build region to carry out post curing of the printed object.

In an embodiment, the second source is positioned to allow radiation from the second source to be directed in a substantially transverse direction relative to an orthogonal axis of an imaginary plane of the carrier to carry out post curing of the printed object.

In an embodiment, the second radiation source comprises a plurality of radiation sources positioned to surround the printed object for directing electromagnetic radiation to carry out post curing of the printed object. Preferably, the second radiation source may be positioned circumferentially relative to the printed object.

In an embodiment, the second radiation source is positioned relative to a mounting arrangement, said mounting arrangement being positioned relative to the printed object to direct electromagnetic radiation to carry out post curing of the printed object.

In an embodiment, the mounting arrangement comprises an enclosure defining an internal volume to allow at least a section of the printed or partially printed object to be positioned therein. Preferably, the enclosure comprises one or more walls defining an internal space for positioning at least a section of the printed object therein. In an embodiment, one or more of the second radiation sources are positioned along the walls of the enclosure to direct electromagnetic radiation in a substantially transverse direction relative to an orthogonal axis of an imaginary plane of the carrier for post curing of the printed object.

In an embodiment, the walls are configured to allow electromagnetic radiation to be reflected or absorbed by the walls for allowing post curing of the printed objects located in the internal volume defined by the enclosure.

In an embodiment, the enclosure comprises a cylindrical or a polygonal cross section for enclosing at least a section of the printed object in an internal space defined by inner walls of the hollow member. In an embodiment, the walls of the enclosure define an internal volume that is sufficiently large for accommodating the build region to allow the carrier with the growing 3D object to move through the internal volume. The growing 3D objects may be positioned anywhere along the carrier and be positioned to move through the internal volume of hollow member. As the growing object is moving through the internal volume of the enclosure, electromagnetic radiation can be directed at the growing 3D object to increase the degree of cure so that no deformation, delamination or any of the other generation faults occurs whilst generating said 3D object.

In an embodiment, the second radiation source is movably mounted to allow movement of the second radiation source relative to the printed objected supported by the carrier. Preferably, the second radiation source is mounted along one or more guiding arrangements to allow movement of the second radiation source along one or more directions.

In an embodiment, the enclosure is mounted along the one or more guiding arrangements. Preferably, the guiding arrangement allows a plurality of enclosures to be movably positioned to locate the printed object in the internal volume defined by the enclosures.

In an embodiment, the carrier comprises a build plate which allows the solidified material to be positioned thereon. In some embodiments, the solidified material may also be adhesively fastened onto the build plate. In an embodiment, the build plate may be transparent to electromagnetic radiation. In another embodiment, the build plate may absorb electromagnetic radiation.

In an embodiment, the carrier further comprises a levelling mechanism for levelling said build plate independently relative to the carrier.

In an embodiment, the apparatus further comprises a locking mechanism for securing the printed object to said build plate of the carrier.

In an embodiment, one or more level sensors measure the distance between said build plate and said build surface.

In an embodiment, the controller receives control input relayed by said level sensors comprising executable instructions to control operation of said levelling mechanism on said carrier.

In an embodiment, the second radiation source comprises one or more of the following: an ultraviolet light source and/or an infrared light source and/or magnetron generating microwave source.

In an embodiment, the additive manufacturing apparatus further comprises: a controller operatively associated with said carrier and the first radiation source for advancing the carrier away from said build surface to form a printed three-dimensional object from the material, while also concurrently controlling operation of the second radiation source to control post curing of the printed object.

In an embodiment, the controller further comprises an input for connecting a sensor, the sensor being provided for sensing one or more characteristics of the partially printed or the printed object supported by the carrier during use and wherein the controller is configured to operate the second radiation source in response to one or more characteristics sensed by the sensor during use.

In an embodiment, the controller is operatively coupled with a drive unit for driving a mounting arrangement and effecting movement of the second radiation source mounted on the mounting arrangement to carry out post curing of the printed object.

In an embodiment, the controller is operable to drive the mounting arrangement and allow the second radiation source to be positioned at a plurality of locations for curing the printed object.

In an embodiment, the controller receives control input comprising executable instructions to control operation of the carrier, the supply unit and the first radiation source for generating the printed object on the build surface during use. Preferably, the control input may comprise information from CAD files, three dimensional scans or geometric and volumetric information related to the printed object.

In an embodiment, the controller is adapted to control duration, intensity, and/or frequency of the electromagnetic radiation emitted by the second source to carry out post curing.

In another aspect, the invention provides a method of forming a three-dimensional object, the method comprising the steps of:
(a) positioning a carrier and a transparent member having a build surface wherein the carrier and the build surface define a build region therebetween wherein the transparent member allows electromagnetic radiation to pass therethrough;
(b) dispensing a material onto the build surface;
(c) providing a first electromagnetic radiation source;
(c) directing electromagnetic radiation from the first source through the transparent member onto the build surface for solidification of the material dispensed on the build surface;
(d) advancing said carrier away from said build surface to form either a three-dimensional intermediate object or the printed object;
(e) providing a second electromagnetic radiation source and locating the second source relative to the three-dimensional intermediate object or the printed object;
(f) directing electromagnetic radiation from the second source through the build region to carry out post curing of the partially printed or the printed object.

In an embodiment, step (f) comprises directing radiation from the second source in a substantially transverse direction relative to an orthogonal axis of the imaginary plane of the carrier.

As previously discussed, the carrier further comprises a build plate which allows the solidified material to be positioned thereon. In an embodiment, the method comprises the step of measuring a distance between the build plate and the build surface. In a further embodiment, the method comprises the step of levelling the build plate. More preferably, the method comprises controlling the levelness of the build plate independently to the levelness of the carrier.

In an embodiment, the method comprises the step of locking the printed object to the build plate once the printed object reaches a predetermined level of cure to hold the weight and maintain stability of the generating object.

In an embodiment, the step of directing electromagnetic radiation from the second source is carried out in response to a sensing step whereby the sensing step comprises sensing one or more characteristics of the partially printed or printed object.

In an embodiment, the method further comprises the step of effecting movement of the second source in one or more directions to carry out post curing of the partially printed or printed object.

In an embodiment, the method comprises operating the carrier supporting the printed object advancing the carrier through the internal volume of the enclosure. In an embodiment, the method further comprises the steps of generating support structures for supporting and connecting a plurality of 3D printed objects.

Preferably, the support structures extend in a substantially parallel and/or perpendicular direction relative to an orthogonal axis of the imaginary plane of the carrier.

In an embodiment, the support structures may be provided for maintaining a fixed distance between a plurality of 3D objects generated by the additive manufacturing method or apparatus.

In some embodiment, the support structures may be disposed at an angle relative to the orthogonal axis to balance 3D printed objects comprising an asymmetrical cross section and/or uneven mass/weight distribution.

In an embodiment, the support structures are part of the generated object.

In an embodiment, the generated support structures are designed in a manner to allow the mechanical locking mechanism to connect with the generated support structures to offer the object stability during the object generating process.

In one embodiment, the printed object is progressively and continuously exposed to electromagnetic radiation from the second source until a substantial portion of the printed object is fully cured or cured to a specified degree of cure.

In another embodiment, one or more sections of the printed object are exposed to electromagnetic radiation from the second source either simultaneously or sequentially until a substantial portion of the printed object is fully cured or cured to a specified degree of cure.

In an embodiment, the material is preferably a photosensitive resin. Preferably, the material forms a polymer composite further comprising a photo initiator for allowing activation of the polymer by the electromagnetic radiation of the second source.

In some embodiments, the polymer composite further comprises additives having high thermal conductivity. In some embodiments, the polymer composite further comprises a hardener.

In some embodiments, the generated 3D object is hollow with a solid or a lattice structured wall.

In some embodiments the generated 3D object is solid.

The term “post-curing” generally refers to the step of directing energy in a form of but not limited to electromagnetic radiation from the second source until the material forming the 3D printed object is densified to achieve a predetermined level of thermal, mechanical and chemical properties. The built-in process of object generation and post curing in the preferred embodiment allows for the generation of large and multiple 3D printed objects. In a preferred embodiment, post curing may be carried out by utilising microwave radiation to activate a form of carbon where the polymer acquires predetermined characteristics to allow for the generation of large or multiple polymer composite objects as an integrated process of object generation. In another preferred embodiment, post curing may be carried out by utilising microwave radiation to perform heat treatment to partially solidified metal objects where the object acquires predetermined characteristics to allow for the generation of large or multiple fully heat-treated metal objects as an integrated process of object generation. In another preferred embodiment post curing may be achieved through microwave induced pyrolysis of a preceramic polymer in order to create large or multiple ceramic objects as an integrated process of object generation. Microwave post-curing of preceramic polymers may require one or more radiation sources for carrying out the post-curing. By way of example, one source may be dedicated to create a green body through cross-linking material and another source may be dedicated to pyrolyzing the green body by use of fillers or additives to form a ceramic body. The desirable level of cure required to create a green body to a ceramic body in order to create large or multiple objects requires an integrated process of object generation and post-curing controlled in conjunction with a sensing step.

Furthermore, the present invention provides a method and apparatus to generate large and multiple small or large objects. The size and the weight of these 3D objects is such that support structures are required to hold the weight and to ensure stability of those 3D objects with asymmetric design and unevenly distributed weight. Multiple support structures may be generated in between the 3D objects to maintain a desired distance between the objects. Such multiple objects may be parallel to the longitudinal axis or one above the other whereby the support structures are substantially parallel to the longitudinal axis to hold in position the lower positioned 3D object. Such multiple objects may be positioned across the build area or in a plane perpendicular to the longitudinal axis whereby the support structures are substantially perpendicular to the longitudinal axis.

The support structures may comprise the same material as used for the generation of the 3D objects or an alternative material. At the same time and in the same way as the 3D objects, the support structures are substantially post cured by the second source to provide sufficient strength to hold in position and maintain stability of the large and heavy generated 3D objects.

In some embodiments, the second source may operate in the Infrared part of the electromagnetic spectrum, providing a post curing process by rapidly heating the growing 3D objects. Large radiating heating capacities can be transmitted in a relative localised area, as compared to thermal heating, therefore enabling temperature based post curing of large growing objects as an integrated part of the 3D generation process without increasing temperature in the build region.

In another embodiment, the second source may operate in the microwave spectrum of the electromagnetic spectrum. The source may be mounted on a mounting arrangement such as a housing enclosing the microwave emitting source. Preferably, the source may be in the form of a resonator with at least one magnetron.

The microwave beams from the second source can be introduced along a wave guide fitted substantially parallel or perpendicular to the outer peripheral longitudinal wall in the resonator. The waveguide may have a spacing relative to the associated outer peripheral longitudinal side such that the microwave beam which is coupled into the resonator by it, is reflected or absorbed on the opposed longitudinal wall section.

The microwave radiation penetrates the growing objects and heat is generated by exciting fillers or other additives from within the object. Consequently, the volumetric post curing with microwave radiation is well suited for those applications where multiple 3D objects are generated simultaneously as well as for large cross sectional 3D objects especially those with internal 3D generated structures which cannot be post cured with UV, visible or infrared light. The post curing is localised thereby not affecting the 3D generation process in the build area.

For small 3D objects or for matching generation speed and post curing rate, the enclosure may be in a stationery position. The post curing in this instance may take place during or after completion of the 3D generation process. However, different 3D generating apparatus may have different 3D object generation speeds which also may vary with the type of photosensitive material used by the apparatus.

The required rate of post curing may not necessarily coincide with the 3D object generation speed. By way of example an object with a denser cross-sectional area will take longer to generate a solid object. Therefore, the faced walls may be movable with a variable speed whereby the growing 3D object moves through the internal volume of the enclosures depending on the post curing requirements of the specific 3D printed object being generated.

By way of another example, if the generation speed is slower than the time required to post cure the growing 3D object, then the 3D object may be post cured one section at the time, i.e. with one section post cured, radiation emission is ceased until such time that the 3D object has grown sufficiently to start post curing the next section.

Alternatively, additional radiation sources may be added to the enclosures to increase the radiation area along the longitudinal axis allowing for the growing 3D object, as it moves along the longitudinal axis, to be exposed to the radiation for a longer period of time. Such additional radiation sources may be incorporated in multiple faced walls whereby each enclosure may have its own adjustable speed. If multiple radiation sources are used but other 3D objects which are generated require shorter exposure times, some of the radiation sources may be switched off for a selected length of time and switched on again when required.

Radiation sources operating in other parts of the electromagnetic spectrum may be also used in the enclosures to suit specific post curing requirements. The method of delivery of these sources may be a continuous release of energy, a pulsed release of energy, or any timing, frequency and intensity that may be required to cure a specific area on an object to a predetermined specification sensed by the sensing equipment.

Any photosensitive material, with material properties required for the 3D object to be generated, may be chosen to generate the 3D objects as described. The photosensitive material may contain some specific additives to enhance the post curing process and aiding to achieve the highest degree of cure possible. As a matter of illustration and without being limited hereto, such additives may be photo initiators for radiation sources of the same frequency as the generation radiation source or for radiation sources of an alternative frequency in the Ultraviolet or Visible spectrum which continue the photo polymerisation process. Other additives may have highly thermal conductive properties to enhance the post curing with Infrared radiation. Furthermore, hardeners, forms of carbon and other additives may be used that enhance the post curing with microwave radiation.

The generated 3D objects may be, but not limited hereto, hollow with a solid wall, with or without some internal support structures or infill, or may have an open lattice structure or alternatively may be solid. More specifically the present invention aims at enabling the generation of large 3D objects These objects may be generated as a single object or may comprise multiple identical or discrete objects across the carrier. These objects may be built in a build region supported by one or more built plates and carriers, and generated on one or more static or dynamic build surfaces, and post cured by one or more secondary radiation sources located in one or more enclosures.

### BRIEF DESCRIPTION OF THE DRAWINGS

In order that this invention may be more readily understood and put into practical effect, reference will now be made to the accompanying drawings which illustrate a preferred embodiment of the invention and wherein:

FIG. 1A (PRIOR ART) is a view of an apparatus for additive manufacturing or generation of 3D objects in a top down configuration as known in the prior art;

FIG. 1B (PRIOR ART) is a view of an apparatus for additive manufacturing or generation of 3D objects in a top down configuration in accordance with the prior art;

FIG. 2 (PRIOR ART) is a view of an apparatus for additive manufacturing or generation of 3D objects in a bottom up configuration;

FIG. 3A (PRIOR ART) is a cross sectional view of a 3D object generated with a bottom up apparatus;

FIG. 3B (PRIOR ART) is a cross sectional view of the same 3D object generated with a top down apparatus;

FIG. 4A is an isometric view of the apparatus 100;

FIG. 4B is an isometric view of the of said apparatus of FIG. 5B with the growing 3D object raised through facing enclosures 150;

FIG. 5A is a concept perspective view of an alternative mounting arrangement 150′ for mounting the second radiation source 160;

FIG. 5B is another perspective view of the mounting arrangement 150′;

FIG. 5C is a detailed view (depicting internal components) of mounting member 150B that forms a part of the mounting arrangement 150′.

FIG. 6 is a block diagram describing the working of a controller 180 that controls one or more operations of the apparatus 100;

FIG. 7 is a concept sectional view of the carrier 110;

FIG. 8 illustrates four alternative embodiments of the facing enclosures 150;

FIG. 9 illustrates various cross-sectional areas of the build surface;

FIG. 10 illustrates various forms of build regions of large 3D objects secured by multiple carriers 110;

FIG. 11A is a sectional view of the apparatus 100 forming a hollow 3D object 33 with a solid wall;

FIG. 11B is a sectional view of the apparatus 100 forming a hollow 3D object 34 with a lattice structured wall;

FIG. 12A is a concept perspective view of the apparatus 100 forming a plurality of multiple identical 3D objects;

FIG. 12B is a concept perspective view of the apparatus 100 forming a plurality of multiple discrete 3D objects;

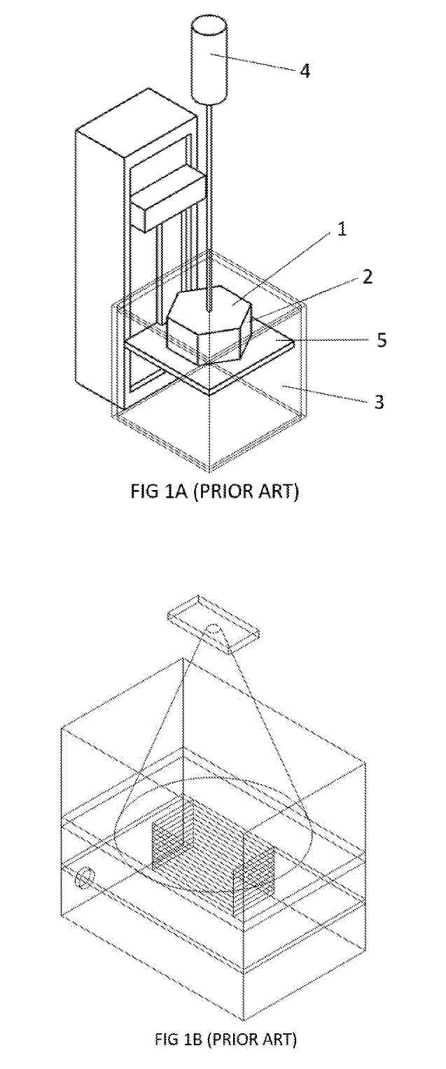

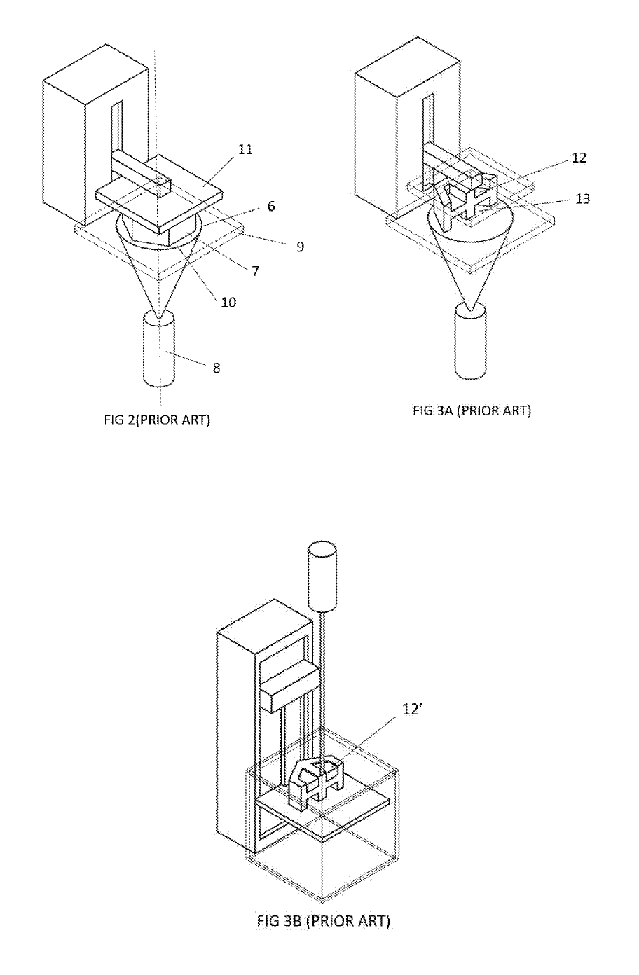

### DETAILED DESCRIPTION

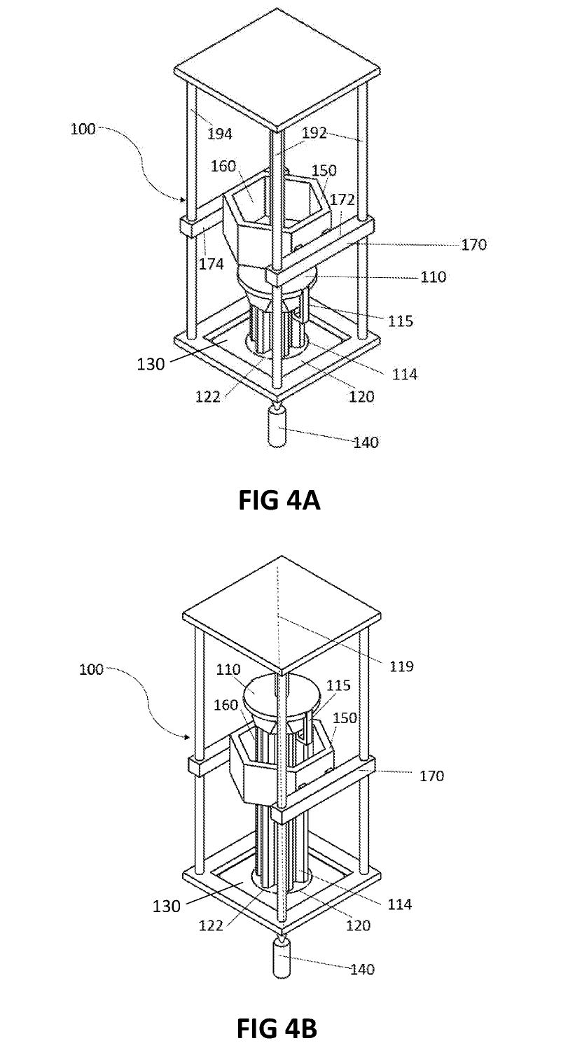

Referring to FIGS. 4A and 4B, an additive manufacturing apparatus 100 in accordance with a preferred embodiment is provided for printing a three-dimensional object 114. The apparatus 100 includes a carrier 110 for supporting the object 114 formed thereon. A transparent member 120 provides a build surface 122 for building the object 114. The build surface 122 and the carrier 110 are spaced apart and together define a build region there-between for allowing formation of the printed object 114. A supply unit in the form of a shallow vat 130 is operatively associated with the build surface 122 and supplies a material (preferably polymerizable liquid to the build surface for solidification or polymerization. A first radiation source 140 is positioned to irradiate the build surface by directing electromagnetic radiation through the transparent member 120 to cure or solidify the material on the build surface to form a solid object.

The apparatus 100 also comprises facing mounting arrangement for mounting a second electromagnetic radiation source 160 that is used for carrying out post curing of the printed object 114. In the preferred embodiment, the mounting arrangement comprises an enclosure 150 which is located for surrounding and positioning a section of the printed object 114 as supported by the carrier 110 during a printing operation within an internal volume defined by the enclosure 150. The internal walls of the enclosure 150 support one or more of the second electromagnetic radiation sources 160 that are preferably positioned along the internal walls of the facing enclosures 150. The configuration of the enclosure 150 allows the second radiation source 160 to be in close proximity relative to the printed object 114. The second radiation source 160 is operable to direct electromagnetic radiation in a substantially transverse direction relative to an orthogonal axis of an imaginary plane of the carrier 110 to carry out post curing of the printed object 114.

In some embodiments, the enclosure(s) 150 may be fixed. In an alternative embodiment, the facing enclosures 150 may be movably positioned. During use, the movement of the carrier 110 results in at least a section of the partially printed object 114 being positioned within an internal volume defined by the enclosures 150. The movement of the carrier 110 results in the movement of the growing object 114, parallel to the orthogonal axis L of the carrier 110 through the internal volume of the facing enclosures 150. Positioning at least a section of the growing object 114 within an internal volume of the enclosures 150 allows a plurality of the second radiation sources 160 (mounted along the internal walls of the enclosure 150) to direct electromagnetic radiation towards the growing object 114 to perform post curing of the section of the growing object 114 positioned within the facing enclosures 150.

In an embodiment, the enclosure 150 is fastened with a guiding arrangement 170 (shown in FIGS. 4A and 4B). Each guiding arrangement 170 comprises a guide members 172 and 174. Each of the guide members 172 and 174 that runs along a corresponding pair of opposed upright members 192 and 194 respectively. The guiding arrangement 170 may be coupled with a drive unit for driving the enclosure 150 up or down along the supporting frame comprising the upright members 192 and 194 in order to vary the position of the enclosure 150 and allow different regions of the printed object 114 to undergo post curing by being exposed to electromagnetic radiation emitted by one or more of the second sources 160 positioned along internal walls of the enclosure 150.

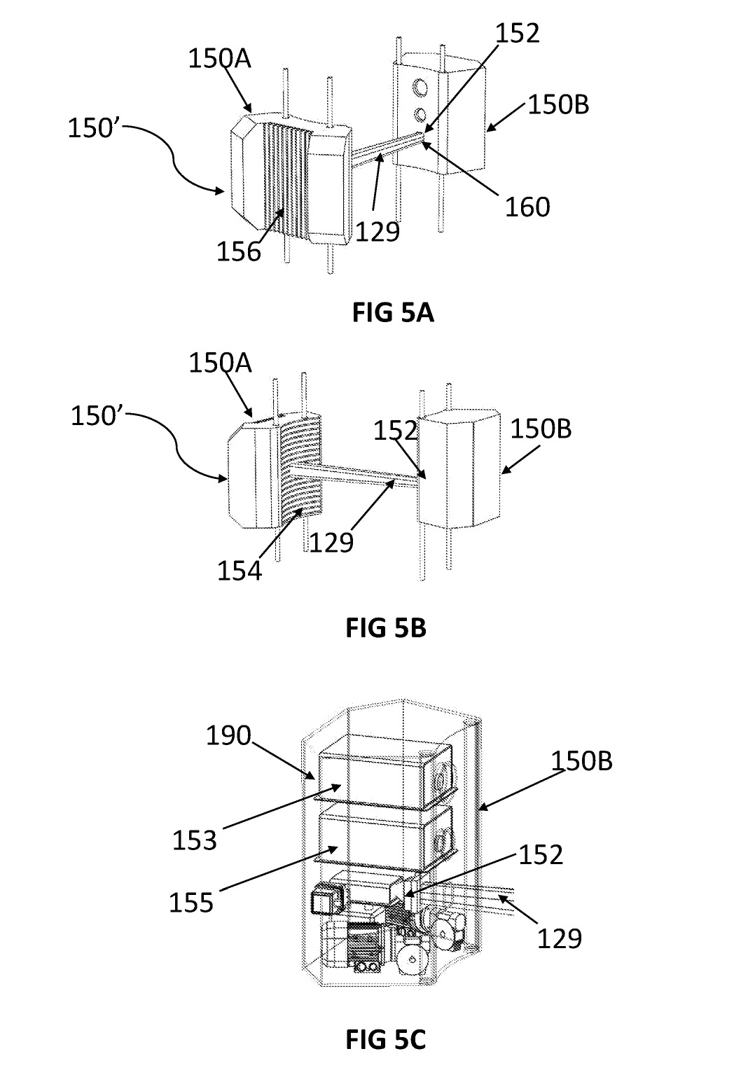

FIGS. 5A, 5B and 5C are illustrations of an embodiment of a mounting arrangement 150′ for mounting the second source 160. The mounting arrangement 150′ comprises oppositely arranged members 150A and 150B which are spaced apart to allow the printed object to be positioned in a space therebetween. The mounting members 150A and 150B are positioned in to be in proximity relative to the build region of the apparatus 100. The mounting members 150A and 150B in other embodiments may be replaced by a single hollow body having a cylindrical or polygonal cross-section (as shown in FIGS. 4A and 4B). One of the mounting members, specifically 150B comprises a radiation emitting module 152 and the other of the members 150A comprises radiation absorbing or reflecting module 154. Furthermore, member 150A may comprise a heat removing device 156 such as a heat sink when member 150A has a radiation absorbing module 154. During use, electromagnetic radiation emissions 129 are directed substantially from 150B towards 150A and typically the printed object 114 is positioned in the path of the radiation 129 to allow post curing of the object. Advantageously, member 150B also comprises sensing devices 190 which may consist of infrared cameras 153 and thermal cameras 155 and/or detectors.

FIG. 5C illustrates a detailed view of member 150B and includes a microwave source for emitting microwaves. The member 150B may also be provided with a drive unit, magnetron, wave guide, high voltage capacitor, and sensing devices as previously described. Parts for the mounting member 150A or 150B may be positioned in any location to effectively emit radiation towards the build region and carry out post curing of the printed object 114.

It must be understood that the mounting arrangement of the second radiation source 160 as encompassed by one or more embodiments is not limiting and alternative configurations may be provided for directing electromagnetic radiation from the second source 160 in order to carry out post curing of the printed object 114 without departing from the spirit and scope of the invention.

The additive manufacturing apparatus may be contained or enclosed within suitable atmospheric conditions for allowing optimal operation of the object generating process. By way of example, inert gas may be used within the contained environment to provide a controlled atmosphere. Venting systems may also be used to remove by-products during the process.

During use, the first partially cured layer of photosensitive material is solidified upon the build plate 113 provided on the carrier 110 (shown in FIGS. 4A, 4B) which is advanced in an upward direction to provide for new photosensitive material to be solidified. The growing 3D object, or objects, remains attached to the build plate of the carrier 110 due to the adhesion forces between the build plate and the solidified photosensitive material, as if the growing object were glued to the build plate.

FIG. 4A is an isometric view of the apparatus 100 wherein the partially printed object 114 is relatively small to the extent that the partially solidified materials are still strong enough to maintain the weight of the growing 3D printed object 114 without undergoing any undesirable deformation, delamination or other faults. FIG. 4B provides an isometric view of the apparatus 100 whereby the 3D printed object 114 has reached a size whereby its weight and or size may cause deformation, delamination or other faults.

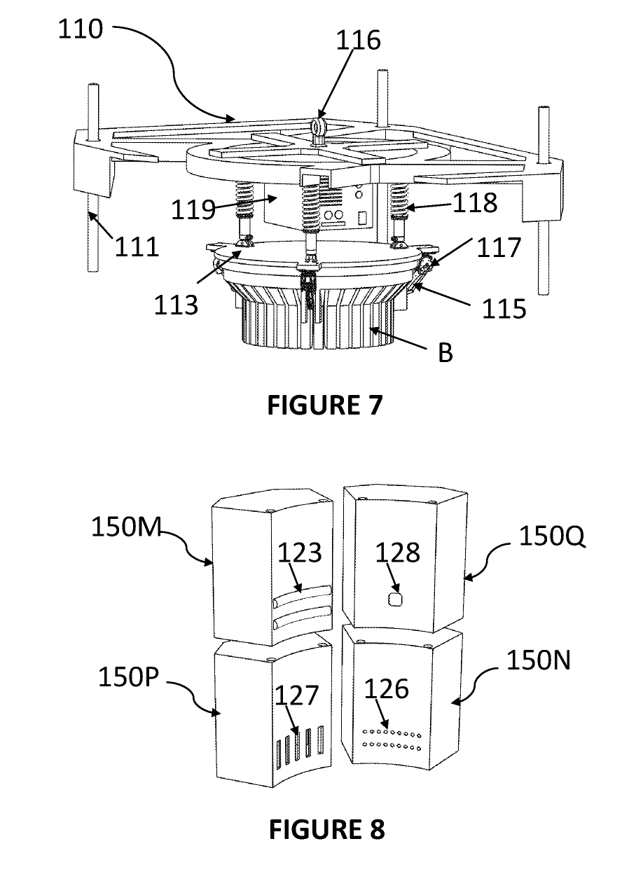

FIG. 7 illustrates a detailed view of the carrier 110. A three-dimensional base B of the object 114 which is secured to the carrier 110 with a mechanical locking arrangement 115. This additional base B can either be in the form of a sacrificial base or can be part of the generated 3D object 114. The applicants have found that during times of generating large and or multiple 3D objects, the combined weight of the growing objects (such as 114) may exceed the relevant adhesions forces. The mechanical locking arrangement 115 secures the base of the printed object 114 in position. The mechanical locking arrangement 115 may be applied manually. Alternatively, the locking arrangement 115 may also be automated to suit the user's 3D printing requirements. Furthermore, the mechanical locking fixtures may be of different designs to suit the growing 3D objects it will be holding in position.

The carrier 110 is lifted by a carrier drive unit 112 (not shown in FIG. 7) that may secure to a fastening feature 116 that lifts the frame of the carrier 110 upwards. In some embodiments, the carrier 110 may be balanced and positioned by guide members 111 (not shown in FIGS. 4A and 4B). The build plate 113 further comprises level sensors 117 that relay instructions to a carrier controller 119 to operate micro controlling levelling devices 118 in order to maintain a level build plate 113. The level sensors 117 measure the distance from the build surface 122 to the build platform plate 113 and continuously send this information to the carrier controller 119.

In an embodiment as shown in FIGS. 4A and 4B, the enclosure 150 comprises a hexagonal cross section. However, the shape of the cross section of the enclosure 150 is not limiting and mounting arrangement may be provided in various other configurations. By way of example, the enclosure 150 may be provided in other polygonal shapes or in a cylindrical shape without departing from the spirit and scope of the invention.

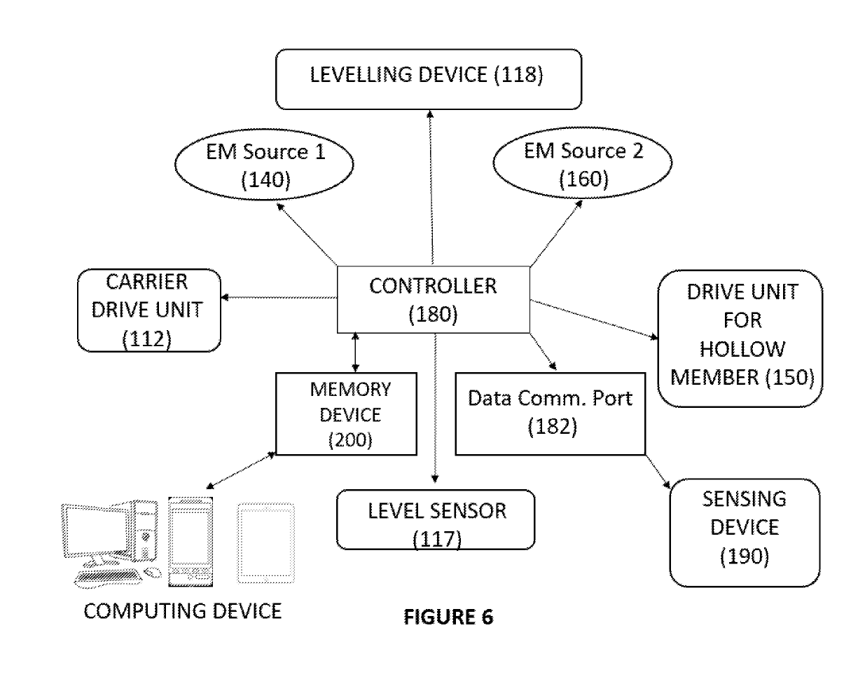

Referring to the block diagram shown in FIG. 6, the additive manufacturing apparatus 100 also comprises a controller 180 that is operatively associated with the carrier 110 and the first radiation source 140 for advancing the carrier 100 away from the build surface 122 to form a printed three-dimensional object from the polymeric liquid. The movement of the carrier 100 may be provided by coupling a carrier drive unit 112 with the carrier 110 for effecting movement of the carrier 110 away from the build surface 122 as the printed object 114 continues to grow. The controller 180 is also adapted to control operation of the second radiation source 160 to control post curing of the printed object 114. By way of example, the controller 180 may be used to control the activation of the second radiation source 160. The controller 180 may also be used for controlling one or more variable parameters associated with the second radiation source 160 such as but not limited to controlling time duration, frequency and intensity of the second radiation source 160. As discussed in the previous sections, in the preferred embodiment, the second radiation source 160 is positioned along the internal walls of the enclosure 150, the facing walls 150 being supported on the guiding arrangement 170 (as previously described) to allow upward and/or downward movement of the enclosure 150. The controller 180 may be configured for controlling a drive unit that allows the movement of the facing enclosures 150 in an upward, downward direction or along a guide member depending on the post curing requirements of the printed object 114. The enclosures 150 may further be mounted on guides located around the build region or may be fitted on devices allowing for free direction of movement in proximity of the build region.

In at least some embodiments, the controller 180 may include a data connection port 182 for communication with a sensing device 190. In some embodiments, the sensing device 190 may take the form of an infrared camera that can sense one or more characteristics of the printed object 114. The controller 180 may be configured to operate the second radiation source 160 and the drive unit (coupled with the enclosure 150 supporting the second radiation source 160) in response to one or more characteristics sensed by the sensing device 190, during use, in order to position the second radiation source 160 at a pre-determined location for achieving post-curing of the printed object 114.

The controller 180 may be coupled with the carrier controller 119 (shown in FIG. 7) to operate the levelling sensors 117 on the build plate 113 of the carrier 110. The movement of the drive unit of the carrier 110 and the levelling devices 118 may operate in conjunction to provide accurate movement of the build plate 113 away from the build surface 122 to meet the requirements of the specified CAD data input. In some embodiments, the controller 180 may include a microcontroller. A memory device 195 accessible by the microcontroller is also provided. The memory device 195 may comprise executable instructions for operating the microcontroller for carrying out one or more operations of the controller 180 as described in the previous sections. A data port assembly 182 in communication with the microcontroller may be provided for establishing a connection with the computing device. The computing device may include a user interface to receive user input from a user. By way of example, a user may provide instructions for performing a 3D printing operation on the user input of the computing device.

FIG. 8 illustrates four alternative embodiments for the mounting arrangement used for mounting one or more of the second radiation sources 160. In one embodiment 150N, the internal wall comprises two rows of electromagnetic radiation point sources 126. The point sources 126 are useful for directing radiation towards the printed object positioned in close proximity to the sources 126. The radiation point sources 126 may be aligned or may be off set to optimise radiation distribution within the internal volume of the facing enclosures 150. In another embodiment 150M, electromagnetic radiation sources 123 are positioned in a substantially circumferential orientation relative to the longitudinal axis (L) of the facing enclosure 150. In yet another embodiment 150P, vertically oriented electromagnetic radiation sources 127 which are positioned in a substantially upright orientation and allow electromagnetic radiation to be directed towards the printed object 114 positioned within the internal volume of the hollow cylindrical member 150C. Another embodiment 150Q comprises magnetrons 128 that are positioned for emitting microwave radiation 129 directed towards the printed object.

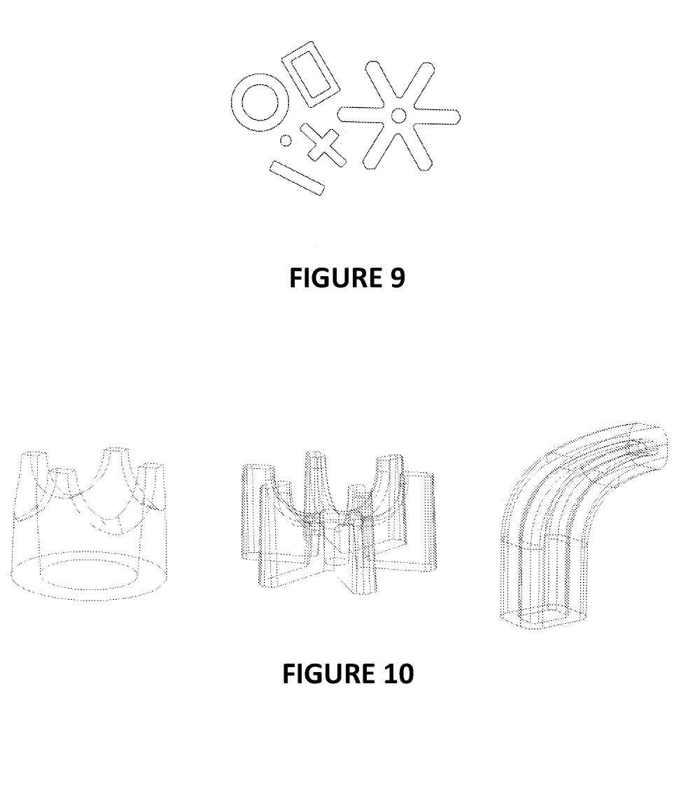

FIG. 9 illustrates various large cross-sectional areas of the build surface 122 provided by the transparent member 120 but the invention is not limited the shapes or forms shown in the illustration. The cross-sectional area of the build surface 122 may take any static or dynamic shape or form provided that one or more of the secondary radiation source 160 emissions can penetrate effectively through the build region. In one embodiment, the cross-sectional area may have an inner open area that is not the build surface 122 allowing for the operation of the facing enclosures at either end of the build region providing that one or more of the secondary radiation source 160 emissions can penetrate effectively through the build region. By way of example but not limited to hereto, the method described may apply to generating aircraft fuselages.

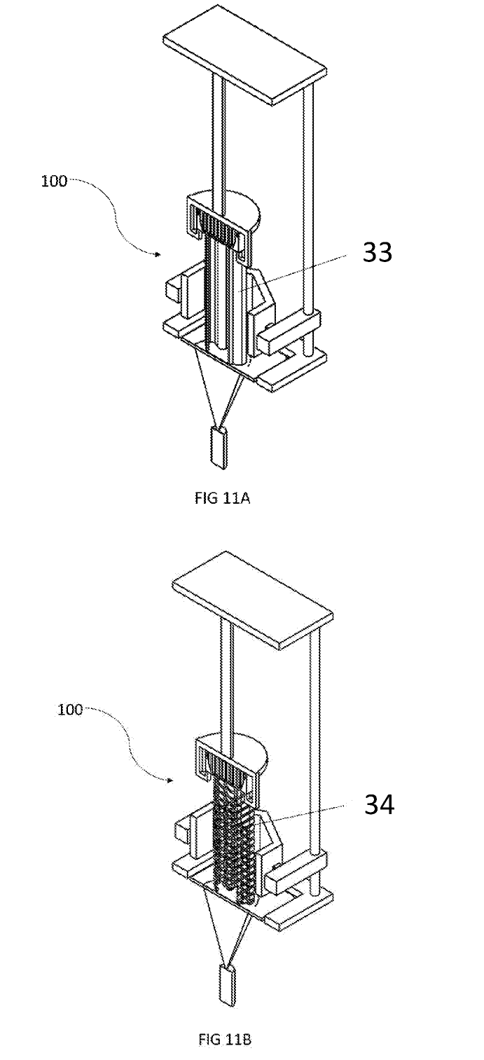

Large build surfaces 122 as described shown in FIG. 9 may utilise one or more carriers 110. FIG. 10 illustrates various forms of build regions for large 3D objects secured by multiple build plates 113 with one or more carriers 110. FIG. 10 also shows a build plate 113 orientated on an angle not perpendicular to the build surface 122. As the 3D object gains sufficient strength to hold its own weight through generating the object and post-curing as an integrated method, the build plate may change orientation which allows for the generation of hollow structures without excessive support structures.

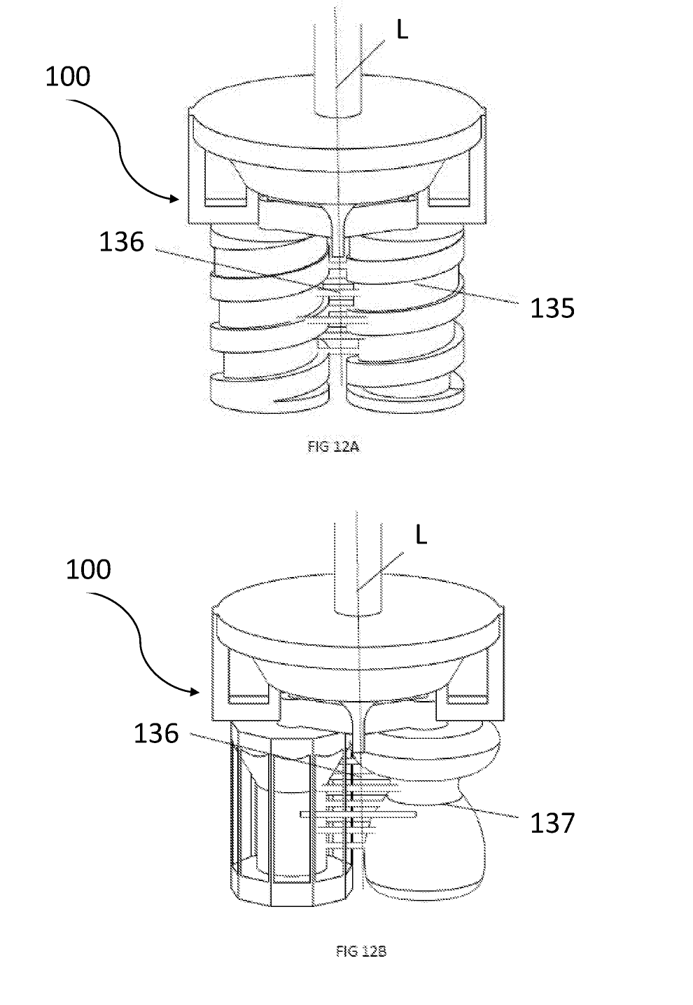

FIG. 11A illustrates the use of the additive manufacturing apparatus 100 whereby the 3D object 114 comprises a thin outer wall or shell whereby the wall is solid. Said hollow thin walled 3D object may have internal structures to increase rigidity as required for specific applications.

FIG. 11B illustrates one embodiment of a 3D object 114 with a thin outer wall whereby said wall comprises a lattice structure. Said hollow thin, lattice structured 3D object may have internal structures to increase rigidity as required for specific applications.

FIG. 12A illustrates the generation of multiple identical 3D printed objects 135. One or more support structures 136 may be generated. The support structures may be substantially perpendicular to a longitudinal axis L. The support structures 136 allow the 3D objects to be maintained a pre-determined inter object distance.

FIG. 12B illustrates the generation of multiple discrete 3D printed objects 137. One or more support structures 136 may be generated to extend in a substantially perpendicular direction (relative to the longitudinal axis L of the facing enclosures 150) for connecting the 3D objects 114 to maintain desired inter object distance.

An exemplary method 500 for forming a three-dimensional object in accordance with an embodiment of the present invention will now be described. Like reference numerals denote like features that have been previously described. The method involves an initial step (510) of providing an input at the user interface of a computing device (such as a desktop computer, a laptop, mobile phone or a tablet device) which includes information (such as a CAD file) that relates to the 3D object to be printed. The controller 180 and the memory device 200 receive the information from the computing device and perform a second step 520 (based on executable instructions stored on the memory device 200) of activating the carrier drive unit 112 to position the carrier 110 at an initial position such that the build surface 122 defined by the position of the transparent member 120, and the build platform 113 on carrier 110 are spaced apart to define a build region therebetween. The supply unit/shallow vat 130 for the material is activated by the controller 180 in accordance with a third step 530 which releases the material on the build surface 122 to commence the 3D printing operation. The controller 180 also carried out a subsequent step 540 which involves directing electromagnetic radiation from the first source 140 through the transparent member 120 onto the build surface 122 for selective solidification of the material on the build surface 122 followed by a carrier advancing step 550 that involves advancing the carrier away from the build surface 122 by controlling the synchronised operation of the carrier drive unit 112 and the levelling mechanism 118 as the size of the 3D printed object 114 gradually increases. After a pre-determined time, a sensing step 560 is carried out by using thermal and infrared cameras in communication with the controller 180 that can signal to stay within predetermined specifications so that no undesirable malfunction such as potential hotspots, delamination, or deformation occurs. Preferably, the sensing step 560 may be carried out once the carrier 110 reaches a pre-determined height which may vary for each object. If any of the sensed characteristics observed or recorded during the sensing step 560 do not satisfy a pre-determined rule, then the second source 160 (a microwave radiation source) may be activated in accordance with a post curing activation step 570 which triggers the second source 160 to direct electromagnetic radiation from the second source 160 in a substantially transverse direction relative to an orthogonal axis of an imaginary plane of the carrier 110 to carry out post curing of the partially printed or the printed object 114. The position of the facing enclosures 150 which in turn determines the location/position of the second source 160 relative to the printed object 114 may be varied in accordance with the post-curing step of 570. The post curing step 570 is determined in accordance with the feedback received during the sensing step 560 by controlling the drive unit for the enclosure 150 (based on the feedback) to specifically direct the microwave radiation from the second source 160 to selectively carry out post curing of any regions of the printed object 114. In some embodiments, the locking arrangement 115 for securing a base of the printed object 114 may be activated once the sensor 190 determines that the base of the printed objected 114 has attained a pre-determined level of any one or more of strength, curing, post curing or any other pre-determined characteristic.

During the development of some of the embodiments, the inventors have identified that the degree of cure, reflected in generated 3D objects being only partially cured, as a limiting factor in the generation of large and multiple generated 3D objects. The embodiments of the present invention aim at providing a method and apparatus to improve the degree of cure and the generation of the growing objects as a joint process so that the size of the partially cured part of the 3D objects never exceeds the critical size beyond which they may be subjected to the issues of deformation and delamination as a result of the objects size and weight.

The terminology used herein is for the purpose of describing particular embodiments only and is not intended to be limiting of the invention. As used herein, the singular is intended to include the plural and the plural is intended to include the singular unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “coupled” with, etc., another element, it can be directly on, attached to, coupled with the other element or intervening elements can also be present. It will also be appreciated by those of skill in the art that references to a structure or feature that is disposed “adjacent” another feature can have portions that overlap or underlie the adjacent feature.

1.-25. (canceled)

26. An additive manufacturing apparatus for generating a three-dimensional object, the apparatus comprising:
(a) a transparent member to allow electromagnetic radiation to pass therethrough, the transparent member providing a build surface wherein the build surface and the carrier define a build region therebetween,
(b) a carrier adapted to be positioned above the transparent member to support said three-dimensional object formed on the build surface;
(c) a supply unit operatively associated with said build surface and configured to supply a material to said build surface for solidification or polymerization during printing of the object;
(d) a first radiation source positioned below the transparent member and directing radiation through the transparent member to solidify the material dispensed by the supply unit on the build surface; and
(e) a second radiation source to generate microwave radiation, the second radiation source being movably positioned relative to the printed object for directing microwave radiation transversely through the build region in between the carrier and the transparent member to carry out post curing of the printed object.

27. An additive manufacturing apparatus in accordance with claim 26 wherein the second source is positioned to allow the microwave radiation from the second source to be directed in a substantially transverse direction relative to an orthogonal axis of an imaginary plane of the carrier to carry out post curing of the printed object.

28. An additive manufacturing apparatus in accordance with claim 26 wherein the second radiation source comprises a plurality of microwave radiation sources positioned to surround the printed object for directing microwave radiation to carry out post curing of the printed object.

29. An additive manufacturing apparatus in accordance with claim 26 wherein the second radiation source is positioned relative to a mounting arrangement, said mounting arrangement being positioned to at least partially surround the printed object.

30. An additive manufacturing apparatus in accordance with claim 29 wherein the mounting arrangement comprises an enclosure for surrounding at least a section of the printed object.

31. An additive manufacturing apparatus in accordance with claim 30 wherein the enclosure comprises one or more internal walls defining an internal volume for positioning at least a section of the printed object therein.

32. An additive manufacturing apparatus in accordance with claim 31 wherein one or more of the second radiation sources are positioned along the internal walls of the enclosure to direct microwave radiation in a substantially transverse direction relative to an orthogonal axis of an imaginary plane of the carrier for post curing of the printed object.

33. An additive manufacturing apparatus in accordance with claim 32 wherein the internal walls of the enclosure are configured to allow the microwave radiation to be reflected or absorbed by the internal walls and allowing post curing of the printed object positioned in the internal volume defined by the enclosure.

34. An additive manufacturing apparatus in accordance with claim 33 wherein the enclosure comprises a cylindrical or a polygonal cross section for enclosing at least a section of the printed object in the internal volume defined by inner walls of the enclosure.

35. An additive manufacturing apparatus in accordance with claim 30 wherein the dimensions of the build surface can be varied and wherein the build surface is movable to allow the electromagnetic radiation from one or more of the second sources to penetrate therethrough into the build region.

36. An additive manufacturing apparatus in accordance with claim 26 wherein the second radiation source is movably mounted to allow movement of the second radiation source relative to the printed object supported by the carrier.

37. An additive manufacturing apparatus in accordance with claim 36 wherein the second radiation source is mounted along one or more guiding arrangements to allow movement of the second radiation source along one or more directions.

38. An additive manufacturing apparatus in accordance with claim 37 when dependent upon claim 5 wherein the enclosure is mounted along the one or more guiding arrangements.

39. An additive manufacturing apparatus in accordance with claim 38 wherein the guiding arrangement allows a plurality of the enclosures to be movably positioned to locate the printed object in the internal volume defined by the enclosures during use.

40. An additive manufacturing apparatus in accordance with claim 26 further comprising a locking mechanism for securing the printed object to the carrier.

41. An additive manufacturing apparatus in accordance with claim 26 wherein the carrier comprises a build plate which allows the solidified material to be positioned thereon and wherein the carrier further comprises a levelling mechanism to level the build plate for securing a generated base of the printed object to the said build plate.

42. An additive manufacturing apparatus in accordance with claim 26 further comprising: a system for generating a three dimensional object, the system comprising a controller operatively associated with said carrier and the first radiation source for advancing the carrier away from said build surface to form either a partially printed intermediate object or a printed three-dimensional object from the material, while concurrently controlling operation of the second radiation source to control post curing of the intermediate object or the printed object.

43. An additive manufacturing apparatus in accordance with claim 17 wherein the controller further comprises an input for connecting a sensor, the sensor being provided for sensing one or more characteristics of the partially printed or the printed object supported by the carrier during use, and wherein the controller is configured to operate the second radiation source in response to one or more characteristics sensed by the sensor during use.

44. An additive manufacturing apparatus in accordance with either claim 42 wherein the controller is operatively coupled with a drive unit for driving a mounting arrangement to effect movement of the second radiation source mounted on the mounting arrangement to carry out post curing of the printed object.

45. An additive manufacturing apparatus in accordance with claim 44 wherein the controller is operable to drive the mounting arrangement and allow the second radiation source to be positioned at a plurality of locations for curing the partially printed or printed object.

46. A method of forming a three-dimensional object, comprising:
(a) positioning a carrier and a transparent member having a build surface wherein the carrier and the build surface define a build region therebetween wherein the transparent member allows electromagnetic radiation to pass therethrough;
(b) supplying the build surface with a material during printing of the object;
(c) providing a first electromagnetic radiation source below the transparent member;
(c) directing electromagnetic radiation from the first source through the transparent member to the build surface for solidification of the material dispensed on the build surface;
(d) advancing said carrier away from said build surface to form either a three-dimensional partially printed intermediate object or the printed object;
(e) providing a second electromagnetic radiation source, the second source comprising a microwave radiation source and movably positioning the second source relative to the three-dimensional intermediate object or the printed object;
(f) directing microwave radiation from the second source at least transversely through the build region to carry out post curing of the partially printed or the printed object.

47. A method in accordance with claim 46 wherein step (f) comprises directing microwave radiation from the second source in a substantially transverse direction relative to an orthogonal axis of the imaginary plane of the carrier.

48. A method in accordance with claim 46 wherein the step of directing electromagnetic radiation from the second source is carried out in response to a sensing step whereby the sensing step comprises sensing one or more characteristics of the partially printed or printed object.

49. A method in accordance with claim 46 further comprising the step of effecting movement of the second source in one or more directions to carry out post curing of the partially printed or printed object.

50. A method in accordance with claim 46 wherein said movable positioning of the second radiation source allows the second source to be moved beyond the carrier.
